(19) United States
(12) Patent Application Publication
(10) Pub. No.: US 2026/0155927 A1
(43) Pub. Date: Jun. 4, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: MITSUYOSHI YUKAWA, Kanagawa (JP)

(21) Appl. No.: 19/400,348

(22) Filed: Nov. 25, 2025

(30) Foreign Application Priority Data
Dec. 3, 2024 (JP) 2024-210127

(51) Int. Cl. H04L 5/00; H04W 28/06

(52) U.S. Cl. CPC H04L 5/0048; H04W 28/06

(57) ABSTRACT

A communication apparatus compliant with an Institute of Electrical and Electronics Engineers (IEEE) 802.11 standard series, the communication apparatus includes at least one memory storing a program, and at least one processor that, upon execution of the stored program, is configured to operate as a transmission unit configured to transmit a physical layer protocol data unit (PPDU) having a preamble including a first universal signal (U-SIG) field, a second U-SIG field including data the same as data in the first U-SIG field, a first ultra high reliability signal (UHR-SIG) field, and a second UHR-SIG field including data the same as data in the first UHR-SIG field, wherein the first U-SIG field and the second U-SIG field are modulated by different modulation methods from each other.

### BACKGROUND

### Field of the Technology

The present disclosure relates to a communication apparatus, a control method, and a storage medium.

### Description of the Related Art

With an increase in the amount of data to be communicated in recent years, a communication technique using a wireless local area network (LAN) or the like is developing. As a major communication standard using a wireless LAN, the Institute of Electrical and Electronics Engineers (IEEE) 802.11 standard series is known. The IEEE 802.11 standard series includes standards such as IEEE 802.11a/b/g/n/ac/ax/be and the like. To further improve the reliability of communication, the IEEE 802.11bn standard is developed as a successor standard to the IEEE 802.11be standard. The IEEE 802.11 Working Group (WG), which formulates the IEEE 802.11bn standard, defines the target, the consideration scope, and the like of this standard in the Ultra High Reliability Study Group (UHR SG) and plans to define the content of a detailed technique that is to be included in the standard in the Task Group bn (TGbn). UHR SG is the abbreviation of Ultra High Reliability Study Group. TGbn is the abbreviation of Task Group bn. The name “UHR” is provided for convenience based on the target that is to be achieved by the successor standard or the main feature of the standard. Thus, the name can be another name in the state where the formulation of the standard is completed. Similarly, the name “IEEE 802.11bn” can also be another name in the state where the formulation of the standard is completed.

As one of the candidates for the technique to be included in the IEEE 802.11bn standard, there is communication using a PLCP protocol data unit (PPDU) for long-distance communication. PPDU is the abbreviation of PLCP protocol data unit. PLCP is the abbreviation of Physical Layer Convergence Protocol. A communication method using a PPDU in a new format termed an enhanced long range (ELR) PPDU as a PPDU for long-distance communication is considered (see Jianhan Liu et al., “Design Targets and Considerations for Enhanced Long Range (IEEE 802.11-24/0873r2)”, IEEE 802.11, 2024). The PLCP protocol data unit is an example of a physical layer (PHY) protocol data unit, and the abbreviation of the physical layer protocol data unit is also PPDU.

However, the details of the format of an ELR PPDU are not defined and not clarified. If this format is not clarified, there is a possibility that a discrepancy in recognition occurs between communication apparatuses in a wireless LAN, and communication using a PPDU for long-distance communication cannot be appropriately performed.

### SUMMARY

In view of the above, one of the purposes of an aspect of the present disclosure is to provide a technique for appropriately performing communication using a PPDU for long-distance communication.

According to an aspect of the present disclosure, a communication apparatus compliant with an Institute of Electrical and Electronics Engineers (IEEE) 802.11 standard series, the communication apparatus includes at least one memory storing a program, and at least one processor that, upon execution of the stored program, is configured to operate as a transmission unit configured to transmit a physical layer protocol data unit (PPDU) having a preamble including a first universal signal (U-SIG) field, a second U-SIG field including data the same as data in the first U-SIG field, a first ultra high reliability signal (UHR-SIG) field, and a second UHR-SIG field including data the same as data in the first UHR-SIG field, wherein the first U-SIG field and the second U-SIG field are modulated by different modulation methods from each other.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a wireless communication system according to an embodiment.

FIG. 2 is a block diagram illustrating an example of a functional configuration of a communication apparatus according to the embodiment.

FIG. 3 is a diagram illustrating an example of a hardware configuration of the communication apparatus according to the embodiment.

FIG. 4 is a flowchart illustrating an example of a communication process executed by the communication apparatus according to the embodiment.

FIGS. 5A and 5B are diagrams illustrating examples of a frame format used to issue a notification of transmission/reception possibility information regarding a PPDU for long-distance communication according to the embodiment.

FIGS. 6A and 6B are diagrams illustrating examples of a frame format of a PPDU for long-distance communication according to the embodiment.

FIG. 7 is a diagram illustrating examples of relationships between a value of a UHR-SIG MCS field and communication parameters according to the embodiment.

### DESCRIPTION OF THE EMBODIMENTS

Embodiments will be described in detail below with reference to the attached drawings. The following embodiments do not limit the content described in the appended claims. Although a plurality of features is described in the embodiments, not all the plurality of features is essential for the present disclosure, and the plurality of features may be optionally combined. Further, in the attached drawings, the same or similar components are designated by the same reference numbers, and are not redundantly described.

### EMBODIMENTS

### (Network Configuration)

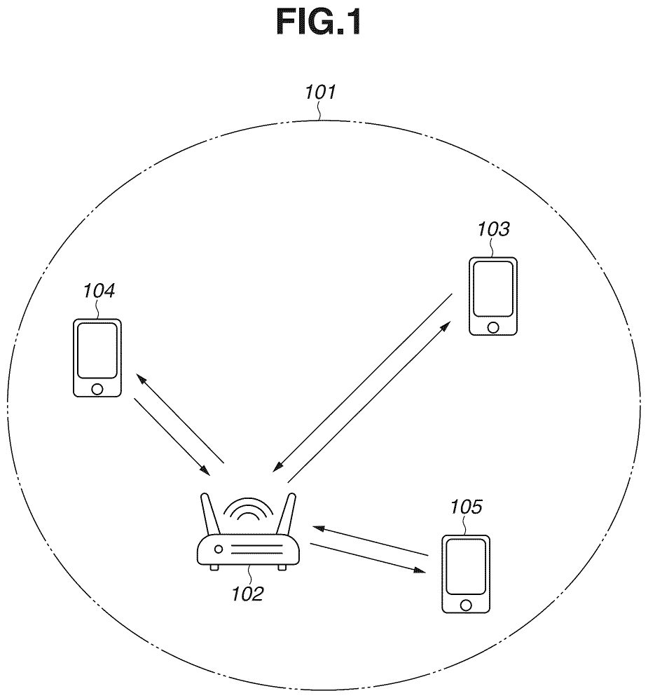

FIG. 1 is a diagram illustrating an example of the configuration of a wireless communication system according to the present embodiment. FIG. 1 illustrates an example of the configuration of a network according to the present embodiment. FIG. 1 illustrates a configuration in which a single access point (AP) 102 and three stations (STAs) 103, 104, and 105 are included as (wireless) communication apparatuses that perform wireless local area network (LAN) communication compliant with the Institute of Electrical and Electronics Engineers (IEEE) 802.11bn standard. An STA is also occasionally referred to as a “non-AP STA”.

As illustrated in FIG. 1, a network formed by the AP 102 is indicated by a circle 101. The STAs 103 to 105 can transmit and receive signals transmitted from and received by the AP 102. In the present embodiment, each of the AP 102 and the STAs 103 to 105 is occasionally collectively referred to as a “communication apparatus 100”. The configuration illustrated in FIG. 1 is merely an example, and for example, another communication apparatus that performs wireless LAN communication may exist in a broader area.

In the present embodiment, the AP 102 is configured to be able to execute a communication method compliant with the IEEE 802.11bn standard. The IEEE 802.11bn standard is a successor standard to the IEEE 802.11be standard. Examples of the main features of the IEEE 802.11bn standard include the functions of achieving high reliability communication, low latency communication, an improvement in throughput in a case where communication traffic is congested, and the like. A wireless frame used in the communication method compliant with this standard can be termed an “Ultra High Reliability (UHR) PPDU”. PPDU is the abbreviation of PLCP protocol data unit. PLCP is the abbreviation of Physical Layer Convergence Protocol.

There is a possibility that the names “UHR”, “IEEE 802.11bn”, and the like are changed to other names when the formulation of the standard is completed. The specification and the claims appended to the specification are applicable to a communication apparatus using all successor standards that are successor standards to the IEEE 802.11be standard. The communication apparatus 100 can be compatible with at least any one of legacy standards that are standards earlier than the IEEE 802.11bn standard. For example, the legacy standards are the IEEE 802.11a/b/g/n/ac/ax/be standards. The communication apparatus 100 may also be compatible with another communication standard such as Bluetooth®, near-field communication (NFC), Bluetooth® Low Energy (LE), ultra-wideband (UWB), Zigbee®, MultiBand OFDM Alliance (MBOA), or the like. NFC is the abbreviation of near-field communication. UWB is the abbreviation of ultra-wideband. MBOA is the abbreviation of MultiBand OFDM Alliance. UWB includes Wireless Universal Serial Bus (USB), Wireless 1394, WiNET, and the like. The communication apparatus 100 can also be configured to support wired communication using an Ethernet cable or wired communication using optical fibers. The communication apparatus 100 can also be configured to support wireless communication using a cellular method such as fifth generation (5G), long-term evolution (LTE), or the like.

For example, the AP 102 is a wireless LAN router, a personal computer (PC), or the like. The present disclosure, however, is not limited to these. The AP 102 may be an information processing apparatus such as a wireless chip capable of executing wireless communication compatible with the IEEE 802.11bn standard or the like. The communication apparatus 100 may be an information processing apparatus such as a wireless chip that supports the transmission and the reception of a PPDU, or the like. In this case, the communication apparatus 100 can be configured to execute various types of control by a hardware circuit within the wireless chip. The communication apparatus 100 can also be configured to execute various types of processing by a processor such as an application-specific instruction set processor (ASIP) or the like, a memory, and a hardware circuit within the wireless chip cooperating with each other. ASIP is the abbreviation of application-specific instruction set processor.

Specific examples of the STAs 103 to 105 include a camera, a tablet, a smartphone, a PC, a mobile phone, a video camera, wearable devices such as smartglasses and a head-mounted display (HMD), and the like. The present disclosure, however, is not limited to these. The STAs 103 to 105 may be an information processing apparatus such as a wireless chip capable of executing wireless communication compatible with the IEEE 802.11 series standards or the like. For example, each of the STAs 103 to 105 may be an Internet-of-Things (IoT) device such as an IoT sensor, a smart lock, a smart sensor, or the like. The IoT sensor may be an acceleration sensor, a photosensor, a humidity sensor, or the like.

The communication apparatus 100 can communicate using wireless signals in frequency bands such as the 2.4 GHz band, the 3.6 GHz band, the 5 GHz band, the 6 GHz band, the 45 GHz band and the 60 GHz band termed millimeter-wave bands, and the like. The frequency bands used by the communication apparatus 100 are not limited to these, and can be the Sub-1 GHz band or the like. The communication apparatus 100 can also communicate using 20 MHz, 40 MHz, 80 MHz, 160 MHz, 320 MHz, 540 MHz, 640 MHz, 1080 MHz, and 2160 MHz bandwidths. The bandwidths used by the communication apparatus 100 are not limited to these, and can be a 240 MHz bandwidth, a 4 MHz bandwidth, or the like. The IEEE 802.11 series standards define a frequency channel using a 20 MHz bandwidth as a basic channel in frequency bands such as the 2.4 GHz band, the 5 GHz band, the 6 GHz band, and the like. These standards also define a plurality of channels that can be used in frequency bands such as the 2.4 GHz band, the 5 GHz band, and the 6 GHz band. In these standards, a certain channel can be used in combination with another channel adjacent to the certain channel. In the present embodiment, the use of a certain channel in combination with another channel adjacent to the certain channel is occasionally referred to as “channel bonding”. A bundle of channels formed of a single channel or two or more channels adjacent to each other is occasionally referred to as a “communication link” (or simply as a “link”). That is, a single link formed of two channels having a 20 MHz bandwidth uses a 40 MHz bandwidth. The communication apparatus 100 may be an AP multi-link device (MLD) or an STA MLD compatible with multi-links that simultaneously establishes a plurality of links and performs communication.

To communicate data with another communication apparatus, the communication apparatus 100 establishes one or more links between the apparatuses. For example, to establish links with the AP 102, each of the STAs 103 to 105 executes a connection procedure with the AP 102. If the connection procedure between each of the STAs 103 to 105 and the AP 102 is completed, links are established between the apparatuses. The links are established, whereby the communication apparatus 100 can access a wireless medium and communicate data and the like with the partner communication apparatus. For example, if a single link using a 160 MHz bandwidth is established between the apparatuses, the communication apparatus 100 communicates using all or some of channels included in the link. The link using the 160 MHz bandwidth can be configured by bundling eight channels having a 20 MHz bandwidth.

### (Configurations of Each of AP and STAs)

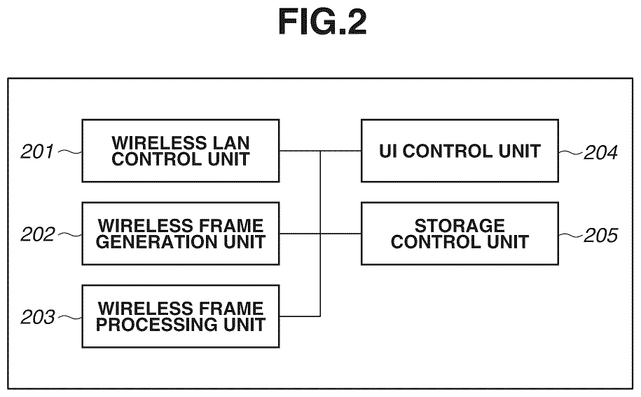

FIG. 2 is a block diagram illustrating an example of the functional configuration of each of the AP 102 and the STAs 103 to 105 (the communication apparatus 100). As illustrated in FIG. 2, each of the AP 102 and the STAs 103 to 105 includes a wireless LAN control unit 201, a wireless frame generation unit 202, a wireless frame processing unit 203, a user interface (UI) control unit 204, and a storage control unit 205 as an example of the functional configuration. For example, these functions can be achieved by a control unit 302 executing a program stored in a storage unit 301 or by a processing function unit of a communication unit 306. FIG. 2 is a diagram illustrating major functions according to the present embodiment and omits other functions. Thus, for example, the communication apparatus 100 can naturally have control functions for the establishment of a normal connection between an AP and an STA and normal communication between an AP and an STA, and functions generally included in a communication apparatus. A plurality of functional blocks illustrated in FIG. 2 may be integrated into a single functional block, or a single functional block in FIG. 2 may be divided into a plurality of functional blocks. The names of the functional blocks illustrated in FIG. 2 are merely examples, and may be changed.

The wireless LAN control unit 201 includes an antenna and a circuit for transmitting and receiving a wireless signal to and from another communication apparatus, and a program for controlling the antenna and the circuit. According to the IEEE 802.11 standard series, the wireless LAN control unit 201 controls communication via a wireless LAN based on a frame generated by the wireless frame generation unit 202. For example, the wireless LAN control unit 201 executes a transmission process for transmitting a frame generated by the wireless frame generation unit 202, and a reception process for receiving a frame transmitted from another communication apparatus.

The wireless frame generation unit 202 generates a frame that is transmitted from the wireless LAN control unit 201. For example, the wireless frame generation unit 202 generates a frame based on setting information stored in the storage unit 301 or user setting information input by a user.

The wireless frame processing unit 203 interprets a wireless frame received by the wireless LAN control unit 201 and causes the wireless LAN control unit 201 to reflect the content of the wireless frame.

The UI control unit 204 includes hardware related to user interfaces such as a touch panel, a button, and the like for receiving an operation on the AP or the STA by the user who uses the AP or the STA, and a program for controlling the hardware. The UI control unit 204 also has a function for presenting information such as the display of an image or the like, the output of a sound, or the like to the user.

The storage control unit 205 controls the writing and reading of data to and from the storage unit 301 such as a read-only memory (ROM), a random-access memory (RAM), or the like that saves a program and data with which the AP or the STA operates.

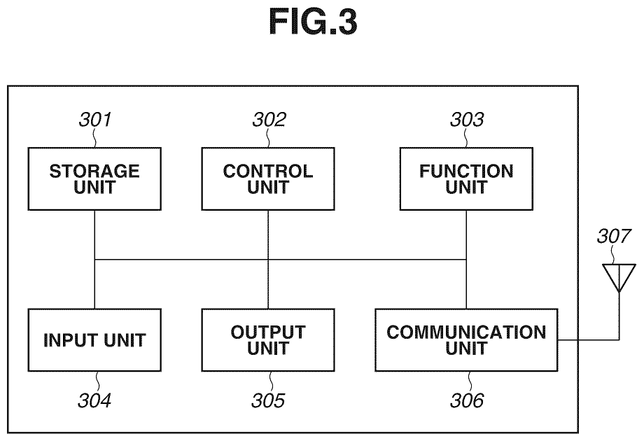

FIG. 3 is a diagram illustrating an example of the hardware configuration of each of the AP 102 and the STAs 103 to 105 (the communication apparatus 100). As illustrated in FIG. 3, each of the AP 102 and the STAs 103 to 105 includes a storage unit 301, a control unit 302, a function unit 303, an input unit 304, an output unit 305, a communication unit 306, and a wireless antenna 307 as an example of the hardware configuration.

The storage unit 301 includes one or more memories such as both or either one of a ROM and a RAM and stores programs for performing various operations described below, and various types of information such as communication parameters (setting information) for wireless communication and the like. As the storage unit 301, in addition to the memories such as the ROM, the RAM, and the like, a storage medium such as a flexible disk, a hard disk, a solid-state drive (SSD), an optical disc, a magneto-optical disc, a compact disc read-only memory (CD-ROM), a compact disc-recordable (CD-R), a magnetic tape, a non-volatile memory card, a digital versatile disc (DVD), or the like may be used. SSD is the abbreviation of solid-state drive. CD-ROM is the abbreviation of compact disc read-only memory. CD-R is the abbreviation of compact disc-recordable. DVD is the abbreviation of digital versatile disc.

For example, the control unit 302 includes one or more processors such as a central processing unit (CPU), a microprocessor unit (MPU), and the like, an application-specific integrated circuit (ASIC), a digital signal processor (DSP), a field-programmable gate array (FPGA), and the like. CPU is the abbreviation of central processing unit. MPU is the abbreviation of microprocessor unit. The control unit 302 controls the entirety of the apparatus by executing a program stored in the storage unit 301. The control unit 302 may control the apparatus by the cooperation of a program and an operating system (OS) stored in the storage unit 301.

The control unit 302 also controls the function unit 303 to execute a predetermined process such as imaging, printing, projection, or the like. The function unit 303 is hardware for the AP or the STA to execute the predetermined process. For example, if the AP or the STA is a camera, the function unit 303 is an imaging unit and performs an imaging process. For example, if the AP or the STA is a printer, the function unit 303 is a printing unit and performs a printing process. For example, if the AP or the STA is a projector, the function unit 303 is a projection unit and performs a projection process. Data to be processed by the function unit 303 may be data stored in the storage unit 301, or may be data communicated with another communication apparatus via the communication unit 306.

The input unit 304 receives various operations from the user. The output unit 305 provides various outputs to the user. The outputs provided by the output unit 305 include at least one of display on a screen, the output of a sound from a loudspeaker, the output of a vibration, and the like. Both the input unit 304 and the output unit 305 may be achieved by a single module as in a touch panel. Each of the input unit 304 and the output unit 305 may be integrated with or separate from the AP or the STA.

The communication unit 306 includes a so-called wireless LAN chip. For example, the communication unit 306 controls wireless communication compliant with the IEEE 802.11 standard series and controls Internet Protocol (IP) communication. In the present embodiment, the communication unit 306 can execute at least processing compliant with the IEEE 802.11bn standard. The communication unit 306 is a processing device that generates a UHR PPDU defined by the IEEE 802.11bn standard, and may have the function of generating a PPDU of a type defined by a standard earlier than the IEEE 802.11bn standard. The communication unit 306 also controls the wireless antenna 307 to transmit and receive a wireless signal for wireless communication. The AP or the STA communicates a content such as image data, document data, video data, or the like with another communication apparatus via the communication unit 306.

The antenna 307 may be composed of physically two or more antennas to achieve multiple-input and multiple-output (MIMO) transmission and reception. The antenna 307 and the communication unit 306 may be configured as separate components, or may be configured as a single module. The wireless antenna 307 is an antenna capable of communicating in the 2.4 GHz band, the 5 GHz band, the 6 GHz band, the 45 GHz band, and the 60 GHz band. Although in FIG. 3, the communication apparatus 100 includes a single antenna, the communication apparatus 100 may include two or more antennas. Alternatively, the communication apparatus 100 may include a different antenna with respect to each frequency band.

Although in the example illustrated in FIG. 3, a configuration is employed in which the communication apparatus 100 includes only a single communication unit 306, the communication apparatus 100 may include a different communication unit for each of a plurality of wireless antennas.

The AP 102 may be a communication apparatus having the configurations illustrated in FIGS. 2 and 3, and may be a so-called communication apparatus dedicated to an AP, such as a wireless LAN router or the like, or may be a communication apparatus having an AP function, such as a smartphone, a camera, a printer, or the like.

(Operation when Communication Apparatus Transmits Data)

Next, a description is given of the processing flow of the communication apparatus 100 in a case where the communication apparatus 100 executes communication using a PPDU for long-distance transmission in the present embodiment.

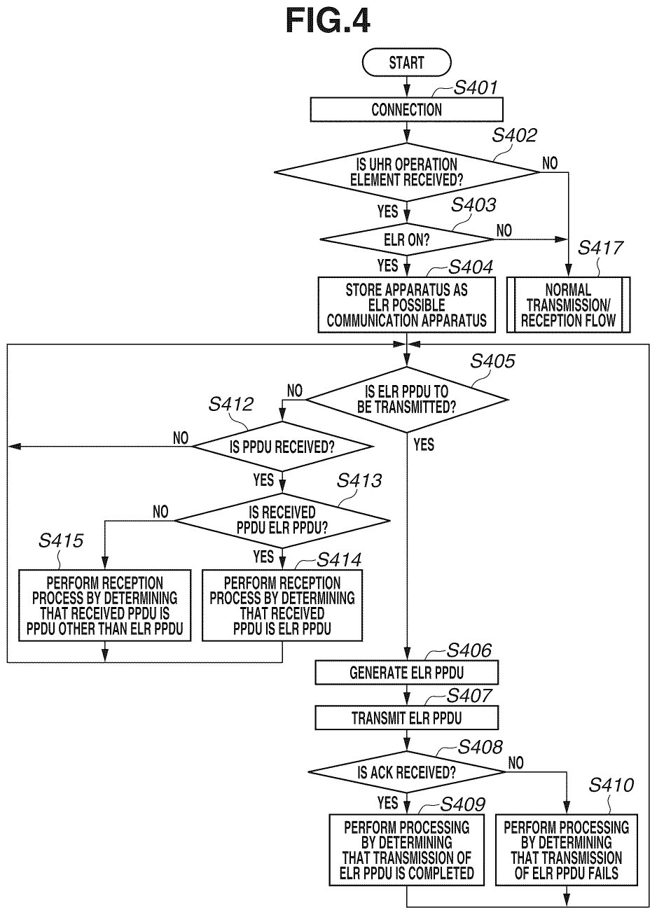

FIG. 4 is a flowchart illustrating an example of processing in a case where the STA 103 executes communication using an enhanced long range (ELR) PPDU with the AP 102. An operation illustrated in the flowchart can be executed by the control unit 302 of the STA 103 reading and executing a computer program stored in the storage unit 301.

In the present embodiment, first, in step S401, the AP 102 and the STA 103 make a connection with each other. That is, the STA 103 connects to the AP 102. Before the AP 102 and the STA 103 execute long-distance communication using an ELR PPDU, a transmission terminal needs to know whether a reception terminal is in the state where the reception of a PPDU for long-distance transmission is possible. In the present embodiment, the transmission terminal is the STA 103, and the reception terminal is the AP 102.

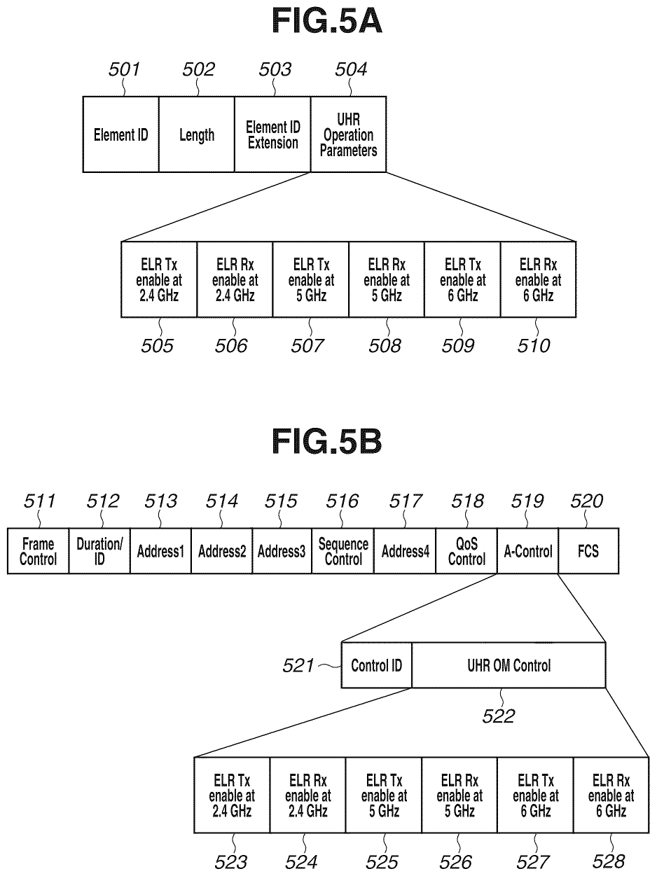

The AP 102 transmits a beacon frame to STAs near the AP 102 and thereby can notify the STAs of whether the AP 102 is in the state where the transmission and reception of this PPDU are possible. The beacon frame includes a signal (information) indicating whether the AP 102 is in the state where the transmission and reception of an ELR PPDU are possible. As an example, the beacon frame includes a UHR operation element illustrated in FIG. 5A. In the specification, information indicating whether the communication apparatus 100 is in the state where the transmission of an ELR PPDU is possible is referred to as “ELR PPDU transmission possibility information”. Information indicating whether the communication apparatus 100 is in the state where the reception of an ELR PPDU is possible is referred to as “ELR PPDU reception possibility information”. In the specification, a signal (information) indicating whether the communication apparatus 100 is in the state where the transmission and reception of an ELR PPDU are possible is referred to as an “ELR PPDU transmission/reception possibility signal (information)” or an “ELR PPDU communication possibility signal (information)”. For example, each of the ELR PPDU transmission possibility information and the ELR PPDU reception possibility information may be 1 bit and take a value “1” or a value “0”. The value “1” indicates that the communication apparatus 100 is in the state where the transmission (or the reception) is possible (transmission (or reception) possible), and the value “0” indicates that the communication apparatus 100 is not in the state where the transmission (or the reception) is possible (the communication apparatus 100 is in the state where the transmission (or the reception) is impossible; transmission (reception) impossible). The values “1” and “O” may have opposite meanings.

The UHR operation element illustrated in FIG. 5A includes an element ID field 501, a length field 502, and an element ID extension field 503. The UHR operation element illustrated in FIG. 5A also includes a UHR operation parameters field 504.

The element ID field 501 and the element ID extension field 503 indicate that this element is a UHR operation element. The element ID field 501 and the element ID extension field 503 have values that are not used by the IEEE 802.11 standards. For example, the element ID field 501 can use a value “255”, and the element ID extension field 503 can use a value “142”.

The UHR operation parameters field 504 includes an ELR Tx enable at 2.4 GHz sub-field 505 and an ELR Rx enable at 2.4 GHz sub-field 506. The UHR operation parameters field 504 also includes an ELR Tx enable at 5 GHz sub-field 507 and an ELR Rx enable at 5 GHz sub-field 508. The UHR operation parameters field 504 also includes an ELR Tx enable at 6 GHz sub-field 509 and an ELR Rx enable at 6 GHz sub-field 510.

The ELR Tx enable at 2.4 GHz sub-field 505 indicates whether the communication apparatus 100 is in the state where the transmission of an ELR PPDU in the 2.4 GHz band is possible. The ELR Rx enable at 2.4 GHz sub-field 506 indicates whether the communication apparatus 100 is in the state where the reception of an ELR PPDU in the 2.4 GHz band is possible. The ELR Tx enable at 5 GHz sub-field 507 indicates whether the communication apparatus 100 is in the state where the transmission of an ELR PPDU in the 5 GHz band is possible. The ELR Rx enable at 5 GHz sub-field 508 indicates whether the communication apparatus 100 is in the state where the reception of an ELR PPDU in the 5 GHz band is possible. The ELR Tx enable at 6 GHz sub-field 509 indicates whether the communication apparatus 100 is in the state where the transmission of an ELR PPDU in the 6 GHz band is possible. The ELR Rx enable at 6 GHz sub-field 510 indicates whether the communication apparatus 100 is in the state where the reception of an ELR PPDU in the 6 GHz band is possible.

Alternatively, a form may be employed in which the above signal indicating whether ELR communication can be executed may be included in an element having another name (e.g., “information element”). A form may be employed in which an element including capability information having a name such as a “UHR capabilities element” or the like includes capability information regarding ELR communication.

The above UHR operation element includes information regarding 2.4 GHz, 5 GHz, and 6 GHz, and information regarding a plurality of bands can be exchanged by communicating the UHR operation element in a particular communication band. However, a form may be employed in which a UHR operation element includes only information regarding a band in which the UHR operation element is transmitted. For example, a UHR operation element transmitted using the 2.4 GHz band can include ELR PPDU transmission possibility information regarding the 2.4 GHz band and ELR PPDU reception possibility information regarding the 2.4 GHz band. Alternatively, a form may be employed in which a UHR operation element includes transmission/reception possibility information regarding some bands. For example, a form may be employed in which a UHR operation element transmitted using the 2.4 GHz band from a communication apparatus compatible with the 2.4 GHz, 5 GHZ, and 6 GHz bands includes transmission/reception possibility information regarding the 2.4 GHz band and transmission/reception possibility information regarding the 6 GHz band.

As another method, a frame used to establish a connection between the AP 102 and the STA 103 may include the above UHR operation element. Examples of the frame used to establish a connection between the AP 102 and the STA 103 include an association request frame, an association response frame, and the like. Additionally or alternatively, frames such as a probe request frame to be transmitted from the STA 103, a probe response frame to be transmitted as a response from the AP 102, and the like may include the above UHR operation element. Frames such as a reassociation request frame, a reassociation response frame, and the like may include the above UHR operation element. As described above, management frames including beacon frames can include the above UHR operation element.

As a form in which a notification of ELR PPDU transmission/reception possibility information is issued, an A-control field in a medium access control (MAC) header can include the information. FIG. 5B illustrates an example of the MAC header format of a frame for achieving this form.

A MAC header illustrated in FIG. 5B includes a frame control field 511, a duration/ID field 512, an address 1 field 513, an address 2 field 514, and an address 3 field 515. The MAC header illustrated in FIG. 5B also includes a sequence control field 516, an address 4 field 517, a QoS control field 518, an A-control field 519, and an FCS field 520.

The A-control field 519 includes a control ID field 521 and a UHR OM control field 522.

The control ID field 521 is a field that stores a value indicating the type of a subsequent field. The control ID field 521 stores a value indicating that the UHR OM control field 522 is subsequent to the control ID field 521. In the present embodiment, the control ID field 521 stores a value “10”, but may store another value so long as the value can avoid duplicating values defined by the legacy standards.

The UHR OM control field 522 includes an ELR Tx enable at 2.4 GHz sub-field 523 and an ELR Rx enable at 2.4 GHz sub-field 524. The UHR OM control field 522 also includes an ELR Tx enable at 5 GHz sub-field 525 and an ELR Rx enable at 5 GHz sub-field 526. The UHR OM control field 522 also includes an ELR Tx enable at 6 GHz sub-field 527 and an ELR Rx enable at 6 GHz sub-field 528.

The ELR Tx enable at 2.4 GHz sub-field 523 indicates whether the communication apparatus 100 is in the state where the transmission of an ELR PPDU in the 2.4 GHz band is possible. The ELR Rx enable at 2.4 GHz sub-field 524 indicates whether the communication apparatus 100 is in the state where the reception of an ELR PPDU in the 2.4 GHz band is possible. The ELR Tx enable at 5 GHz sub-field 525 indicates whether the communication apparatus 100 is in the state where the transmission of an ELR PPDU in the 5 GHz band is possible. The ELR Rx enable at 5 GHz sub-field 526 indicates whether the communication apparatus 100 is in the state where the reception of an ELR PPDU in the 5 GHz band is possible. The ELR Tx enable at 6 GHz sub-field 527 indicates whether the communication apparatus 100 is in the state where the transmission of an ELR PPDU in the 6 GHz band is possible. The ELR Rx enable at 6 GHz sub-field 528 indicates whether the communication apparatus 100 is in the state where the reception of an ELR PPDU in the 6 GHz band is possible.

The communication apparatus 100 transmits a data frame such as a QoS data frame, a QoS null frame, or the like including the above MAC header and thereby can issue a notification of ELR PPDU transmission/reception possibility information.

Based on information included in any of the above various frames, the AP 102 can notify the STA 103 as the communication partner of whether the AP 102 is in the state where the transmission and reception of an ELR PPDU are possible. By a similar method, the STA 103 can also notify the AP 102 of whether the STA 103 is in the state where the transmission and reception of an ELR PPDU are possible.

For example, the ELR PPDU transmission/reception possibility information can be determined based on capability information regarding the communication apparatus 100. The ELR PPDU transmission/reception possibility information can also be determined or changed according to the communication state or the communication environment of the communication apparatus 100. For example, an ELR PPDU has the feature of setting the communication rate to be low, repeating a particular field, or the like to improve (extend) the communication distance. Thus, the time length of the ELR PPDU tends to be long. Thus, in a case where the degree of congestion of communication in a basic service set (BSS) to which the communication apparatus 100 belongs is high, the communication apparatus 100 can determine that communication using an ELR PPDU is not to be performed for the purpose of reducing the degree of congestion of communication. The case where the degree of congestion of communication in the BSS is high is, for example, a case where the throughput is less than or equal to a predetermined value, a case where the number of STAs connected to the AP is greater than or equal to a predetermined number, a case where the usage rate of the wireless resource is greater than or equal to a predetermined value, or the like, or the combination of these cases. As described above, the communication apparatus 100 can change the ELR PPDU transmission/reception possibility information according to the degree of congestion of communication in the BSS to which the communication apparatus 100 belongs, and issue a notification of the changed ELR PPDU transmission/reception possibility information.

In a case where another communication technique for extending the communication distance can be used, the communication apparatus 100 can determine that an ELR PPDU is not to be used. The case where another communication technique can be used is a case where long-distance communication can be performed via a third party other than the transmitter and the receiver, a case where transmission is performed with the maximum allowable transmission power or transmission power greater than or equal to a predetermined value, a case where a particular frequency band is used, or the like, or the combination of these cases. For example, the third party other than the transmitter and the receiver is a relay apparatus (a repeater or a relay). If the communication apparatus 100 determines that communication using an ELR PPDU is not to be performed, the communication apparatus 100 can make the transmission and reception of an ELR PPDU impossible. That is, the communication apparatus 100 can set the ELR PPDU transmission/reception possibility information to a value indicating that the communication apparatus 100 is not in the state where the transmission and reception of an ELR PPDU are possible (is in the state where the transmission and reception of an ELR PPDU are impossible), and issue a notification of the set ELR PPDU transmission/reception possibility information.

The description returns to FIG. 4. If the STA 103 receives a UHR operation element transmitted from the AP 102 (Yes in step S402), then in step S403, the STA 103 determines whether the AP 102 can execute ELR communication. If the AP 102 can execute ELR communication (Yes in step S403), then in step S404, the STA 103 stores the AP 102 as a communication apparatus that can execute communication using an ELR PPDU (referred to as an “ELR possible communication apparatus”).

If, on the other hand, the STA 103 does not receive a UHR operation element (No in step S402), the processing proceeds to step S417. If the AP 102 cannot execute ELR communication (No in step S403), the processing proceeds to step S417.

If a transmission buffer has data to be transmitted from the STA 103, i.e., if the STA 103 transmits an ELR PPDU (Yes in step S405), then in step S406, the STA 103 generates an ELR PPDU. In step S407, the STA 103 transmits the ELR PPDU to the communication apparatus as the transmission destination.

If the STA 103 receives an ACK (acknowledgement) frame from the communication apparatus as the transmission destination (Yes in step S408), then in step S409, the STA 103 performs processing by determining that the transmission of the ELR PPDU is completed. Then, the processing returns to step S405. If, on the other hand, the STA 103 does not receive an ACK frame (No in step S408), then in step S410, the STA 103 performs processing by determining that the transmission of the ELR PPDU fails. Then, the processing returns to step S405. If the transmission fails, the STA 103 may execute the transmission (retransmission) up to a certain number of times, or may end the transmission by determining that the transmission is impossible.

If the transmission buffer does not have data to be transmitted from the STA 103 (No in step S405), then in step S412, the STA 103 determines whether the STA 103 receives a PPDU.

If the STA 103 receives a PPDU (Yes in step S412), and if the received PPDU is an ELR PPDU (Yes in step S413), then in step S414, the STA 103 performs a reception process by determining that the received PPDU is as an ELR PPDU. Then, the processing returns to step S405. If, on the other hand, the received PPDU is not an ELR PPDU (No in step S413), then in step S415, the STA 103 performs a reception process by determining that the received PPDU is a PPDU other than an ELR PPDU. Then, the processing returns to step S405.

If the STA 103 does not receive a PPDU in step S412 (No in step S412), the processing returns to step S405.

In step S417, the STA 103 performs a normal transmission/reception flow not for long-distance communication.

### (Wireless Frame Structure)

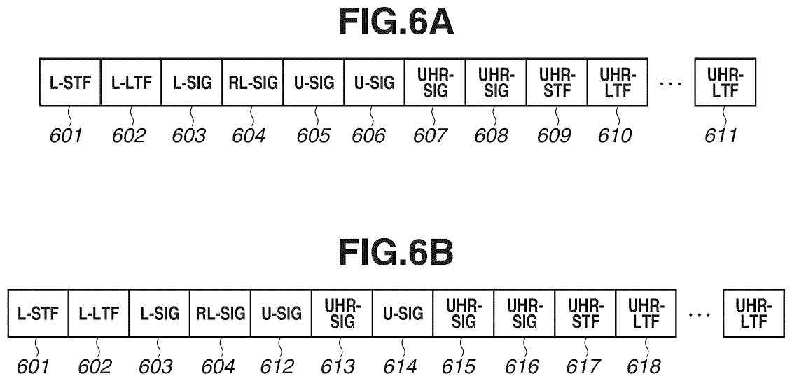

Next, an example of an ELR PPDU transmitted in the present embodiment is described. FIGS. 6A and 6B are diagrams illustrating examples of the frame format of a PPDU for long-distance communication (an ELR PPDU).

An ELR PPDU illustrated in FIG. 6A includes fields such as a short training field (STF), a long training field (LTF), and a signal (SIG).

A beginning portion of the ELR PPDU illustrated in FIG. 6A includes a legacy short training field (L-STF) 601, a legacy long training field (L-LTF) 602, and a legacy signal (L-SIG) 603 for ensuring backward compatibility with the IEEE 802.11a/b/g/n/ax/be standards. The L-LTF 602 is placed immediately after the L-STF 601, and the L-SIG 603 is placed immediately after the L-LTF 602. The ELR PPDU illustrated in FIG. 6A further includes a repeated legacy signal (RL-SIG) 604 placed immediately after the L-SIG 603. In the RL-SIG 604, the content of the L-SIG 603 is repeatedly transmitted. The RL-SIG 604 enables a receiver to recognize that the PPDU is compliant with the IEEE 802.11ax standard or later. In some cases, the RL-SIG 604 may be omitted in the IEEE 802.11bn. Instead of the RL-SIG 604, a field that enables the receiver to recognize that the PPDU is compliant with the IEEE 802.11bn may be provided. The fields of the ELR PPDU do not necessarily need to be arranged in the orders illustrated in FIG. 6A, and the ELR PPDU may include a new field not illustrated in FIG. 6A.

The L-STF 601 is used to, for example, detect a PHY frame signal, perform automatic gain control (AGC), or detect a timing.

The L-LTF 602 is used to, for example, synchronize frequencies and times with high accuracy or acquire channel state information (CSI).

A form may be employed in which in the case of an ELR PPDU, power is boosted by 3 dB, for example, on the L-STF 601 and the L-LTF 602 compared to a PPDU in another format. The amount of the power boosting is not limited to 3 dB. The power boosting improves the signal-to-noise ratio (SNR) of each of these fields, and an improvement in the ELR PPDU transmission possible distance between a transmission terminal and a reception terminal can be expected.

The L-SIG 603 is used to transmit control information including a data transmission rate and a PHY frame length. A legacy device compliant with the IEEE 802.11a/b/g/n/ax/be standards can decode the above various legacy fields.

The ELR PPDU illustrated in FIG. 6A further includes a universal signal (U-SIG) field 605 placed immediately after the RL-SIG 604 and including information common to the IEEE 802.11be and later standards. The ELR PPDU illustrated in FIG. 6A further includes a U-SIG field 606 composed of the same data as that of the U-SIG field 605 subsequent to the U-SIG field 605. A U-SIG field is also occasionally referred to simply as a “U-SIG”.

Table 1 illustrates an example of the configuration of each of the U-SIG fields 605 and 606. Each of the U-SIG fields 605 and 606 is a field that can include information regarding the repetitions of subsequent predetermined fields. A U-SIG field (each of the U-SIG fields 605 and 606) is composed of a U-SIG 1 field and a U-SIG 2 field.

The U-SIG 2 field includes a UHR-SIG MCS field indicating a modulation and coding scheme (MCS) used to modulate a subsequent UHR-SIG field. A UHR-SIG field is also occasionally referred to simply as a “UHR-SIG”.

The name “UHR-SIG field” is a name provided for convenience to identify a SIG field compatible with the IEEE 802.11bn standard. Thus, another name may be used instead of the name “UHR-SIG field”.

A SIG field compatible with or related to a predetermined standard may be composed of a plurality of SIG fields. For example, the SIG field compatible with or related to the predetermined standard may be composed of two SIG fields such as a UHR-SIG-A field and a UHR-SIG-B field, or may be composed of three or more SIG fields.

Although in the present embodiment, an ELR PPDU compatible with the UHR standard is described as an example, if a PPDU is compatible with a predetermined standard other than the UHR, the name “UHR-SIG” may be replaced by another name.

The subsequent UHR-SIG field can have a plurality of repetition structures, and the U-SIG 2 field includes a number of UHR-SIG repetition field specifying the number of UHR-SIG fields. The value stored in the number of UHR-SIG repetition field may be the number of UHR-SIG fields, or may be a number obtained by subtracting a certain value from the number of UHR-SIG fields. For example, a number obtained by subtracting 1 from the number of UHR-SIG fields can be stored in the number of UHR-SIG repetition field.

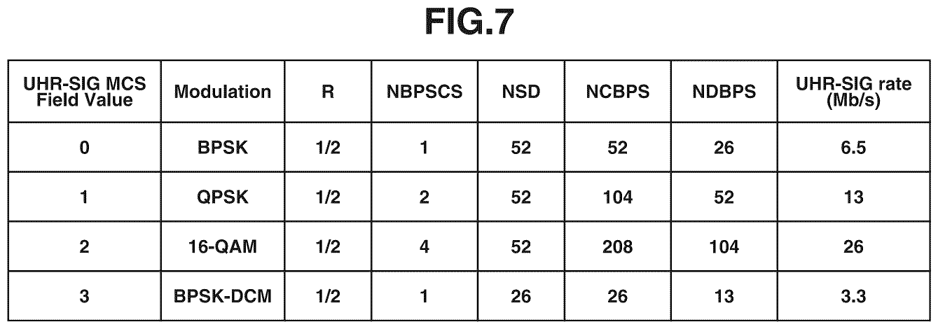

The UHR-SIG MCS field specifies the MCS of each subsequent UHR-SIG field. FIG. 7 illustrates examples of the details of the MCS of each UHR-SIG field.

FIG. 7 is a diagram illustrating examples of the relationships between the value (the index value) of the UHR-SIG MCS field and communication parameters according to the present embodiment.

In the examples illustrated in FIG. 7, the communication parameters include a modulation method (modulation), a code rate (R), the number of coded bits per subcarrier per spatial stream (NBPSCS), and the number of data subcarriers (NSD). In the examples illustrated in FIG. 7, the communication parameters also include the number of coded bits per symbol (NCBPS), the number of data bits per symbol (NDBPS), and a UHR-SIG rate.

Although in the present embodiment, the UHR-SIG MCS field is 2 bits, the number of bits of the UHR-SIG MCS field may be another value. For example, a form may be employed in which the MCS of each UHR-SIG field is fixed by binary phase-shift keying (BPSK) and is not specified in the U-SIG field. In the case of an ELR PPDU, the value of the UHR-SIG MCS field may be a fixed value (e.g., a value “0” illustrated in FIG. 7). That is, a form may be employed in which in the case of an ELR PPDU, the MCS of each UHR-SIG field is fixed, but the UHR-SIG MCS field indicates the MCS.

Although other fields have formats according to a U-SIG field format formulated by the IEEE 802.11be standard, fields included in the U-SIG field do not necessarily need to be fields illustrated in table 1.

TABLE 1

| | Bit | | Number | |
|---|---|---|---|---|
| | Position | Field | Of Bits | Description |
| U- | B0-B2 | PHY Version | 3 | Identifier identifying different |
| SIG | | Identifier | | PHY versions |
| 1 | B3-B5 | Bandwidth | 3 | Indicate bandwidth |
| | B6 | UL/DL | 1 | Indicate for which of UL and |
| | | | | DL PPDU is designed |
| | B7-B12 | BSS Color | 6 | Identifier of BSS |
| | B13-B19 | TXOP | 7 | Indicate whether dual carrier |
| | | | | modulation is applied to data |
| | | | | field. |
| | | | | If STBC field is 0: 1 |
| | | | | (If both DCM and STBC fields |
| | | | | are 1, neither is applied) |
| | | | | If DCM is not applied: 0 |
| | B20-B25 | Disregard | 6 | Set all to 1 as values to be |
| | | | | ignored |
| U- | B0-B1 | PPDU Type And | 2 | Information regarding type of |
| SIG | | Compression Mode | | PPDU |
| 2 | B2-B6 | Punctured Channel | 5 | Information regarding |
| | | Information | | puncture |
| | B7-B8 | UHR-SIG MCS | 2 | MCS of each subsequent |
| | | | | UHR-SIG field |
| | B9-B13 | Number Of UHR- | 5 | Value obtained by subtracting |
| | | SIG Symbols | | 1 from number of UHR-SIG |
| | | | | symbols |
| | B14-B15 | Number Of UHR- | 2 | Number of repetitions of UHR- |
| | | SIG repetition | | SIG fields |
| | B16-B19 | CRC | 4 | CRC of bits 0-41 in U-SIG |
| | | | | field |
| | B20-B25 | Tail | 6 | Terminate trellis of |
| | | | | convolutional decoder. Set to |
| | | | | 0. |

The modulation method for the U-SIG field 605 is a BPSK method. The modulation method for the U-SIG field 606 is the BPSK method, but is a QBPSK (quadrature BPSK) method in which the phase of a modulated signal differs by 90 degrees from the modulation of the U-SIG field 605. A communication apparatus having received this frame (ELR PPDU) can determine that the received frame (PPDU) is an ELR PPDU based on the following (1) and (2): (1) The U-SIG fields 605 and 606 are successive; and (2) Modulated signals are different in phase from each other (modulated by modulation methods different from each other). As a method for determining that the received PPDU is an ELR PPDU, another method is also considered. For example, this method may include the following (a) and (b): (a) It is determined whether the remainder of dividing the value of a length field included in the RL-SIG field 604 by 3 is a value determined in advance; and (b) (For example, if the remainder is the value determined in advance) the difference between the modulation methods for the U-SIG fields 605 and 606 is determined. For example, the value determined in advance is 2. The modulation method for the U-SIG field 605 and the modulation method for the U-SIG field 606 are differentiated from each other, whereby it is possible to perform long-distance communication without a discrepancy in recognition between communication apparatuses.

In the present embodiment, the modulation method for the U-SIG field 605 and the modulation method for the U-SIG field 606 are the BPSK method and the QBPSK method, respectively. The present disclosure, however, is not limited to this. As the modulation methods for the U-SIG field 605 and the U-SIG field 606, other modulation methods different from each other may be used.

The description returns to FIG. 6A. Subsequent to the U-SIG fields 605 and 606, a UHR-SIG field 607 for transmitting control information for the UHR exists. A plurality of UHR-SIG fields can exist. As described above, the number of UHR-SIG fields can be specified by the number of UHR-SIG repetition field included in each of the U-SIG fields 605 and 606. In the present embodiment, a case is illustrated where the value of the number of UHR-SIG repetition field is 2, i.e., the number of UHR-SIG fields is two. Subsequent to the UHR-SIG field 607, a UHR-SIG field 608 composed of the same data as that of the UHR-SIG field 607 exists.

The number of UHR-SIG fields can be specified by a U-SIG field in the above description, but may be a fixed number. The number of UHR-SIG fields may be the same as the number of U-SIG fields. In this case, the number of UHR-SIG fields may be variable, and the number of UHR-SIG fields may be indicated by a (e.g., new) field or element in another field preceding the UHR-SIG fields.

The following table 2 illustrates examples of elements included in each UHR-SIG field. The UHR-SIG field is a field that can include information regarding the repetitions of subsequent predetermined fields. The UHR-SIG field includes a GI+LTF size field specifying the length of a guard interval (GI) and the number of subsequent UHR-LTF fields. For example, the GI+LTF size field indicates the number of LTFs and the pattern of the GI as follows. If the value of the GI+LTF size field is 0, this indicates that the number of LTFs is two and the GI=0.8 microseconds. If the value of the GI+LTF size field is 1, this indicates that the number of LTFs is two and the GI=1.6 microseconds. If the value of the GI+LTF size field is 2, this indicates that the number of LTFs is four and the GI=0.8 microseconds. If the value of the GI+LTF size field is 3, this indicates that the number of LTFs is four and the GI=3.2 microseconds. However, the number of LTF fields and the value of the GI length may not be the above values, and the GI+LTF size field may be other than 2 bits. Alternatively, a form may be employed in which a GI+LTF size field is included in a U-SIG field.

TABLE 2

| Bit | | Number | |
|---|---|---|---|
| Position | Field | Of Bits | Description |
| B0-B3 | Spatial Reuse | 4 | Value regarding whether space can |
| | | | be reused |
| B4-B5 | GI + LTF Size | 2 | Indicate GI length and number of |
| | | | UHR-LTFs |
| B6-B8 | Number Of UHR- | 3 | Number of UHR-LTF symbols |
| | LTF Symbols | | |
| B9 | LDPC Extra Symbol | 1 | Indicate presence or absence of |
| | Segment | | LDPC extra symbol segment |
| B10-B11 | Pre-FEC Padding | 2 | Value regarding pre-FEC padding |
| | Factor | | |
| B12 | PE Disambiguity | 1 | Value regarding packet extension |
| B13-B16 | Disregard | 4 | Set all to 1 |
| B17-B19 | Number Of Non- | 3 | Number obtained by adding 1 to |
| | OFDMA Users | | number of non-OFDMA users |

The ELR PPDU illustrated in FIG. 6A further includes an STF for the UHR (a UHR-STF 609) and LTFs for the UHR (a UHR-LTF 610, . . . , a UHR-LTF 611). A form may be employed in which in the case of an ELR PPDU, power is boosted by 3 dB, for example, on the UHR-STF 609 and the UHR-LTF 610 ( . . . , the UHR-LTF 611) compared to a PPDU in another format. The amount of the power boosting is not limited to 3 dB. Consequently, the UHR-STF 609 and the UHR-LTF 610 ( . . . , the UHR-LTF 611) subsequent to the UHR-SIGs 607 and 608 have transmission intensities higher than those of other fields. The power boosting improves the SNR of each of these fields, and an improvement in the ELR PPDU transmission possible distance between a transmission terminal and a reception terminal can be expected.

The ELR PPDU includes a data field and a packet extension field (not illustrated) after these fields for control. The fields from the L-STF to the UHR-LTFs included in the ELR PPDU are termed a “PHY preamble”.

The name “UHR-SIG field” is a name provided for convenience to identify a SIG field compatible with the IEEE 802.11bn standard. Thus, another name may be used instead of the name “UHR-SIG field”.

A SIG field compatible with or related to a predetermined standard may be composed of a plurality of SIG fields. For example, the SIG field compatible with or related to the predetermined standard may be composed of two SIG fields such as a UHR-SIG-A field and a UHR-SIG-B field, or may be composed of three or more SIG fields.

Although in the present embodiment, an ELR PPDU compatible with the UHR standard is described as an example, if a PPDU is compatible with a predetermined standard other than the UHR, the name “UHR-SIG” may be replaced by another name. “UHR-SIG” may be replaced by “ELR-SIG”. For example, “UHR-STF” and “UHR-LTF” may be replaced by other names such as “ELR-STF”, “ELR-LTF”, and the like, respectively.

As another form of the ELR PPDU, a format illustrated in FIG. 6B is possible. This format is described below.

An L-STF 601 to an RL-SIG field 604 in the ELR PPDU format illustrated in FIG. 6B are the same as the L-STF 601 to the RL-SIG field 604, respectively, illustrated in FIG. 6A, and therefore are not described.

The ELR PPDU illustrated in FIG. 6B includes a U-SIG field 612 and a UHR-SIG field 613 placed immediately after the RL-SIG 604 and including information common to the IEEE 802.11be and later standards. Then, a U-SIG field 614 and a UHR-SIG field 615 are subsequent to the UHR-SIG field 613 in this order.

The U-SIG field 612 and the UHR-SIG field 613 are modulated by the BPSK method, and the U-SIG field 614 and the UHR-SIG field 615 are modulated by the QBPSK method. A communication apparatus having received this frame (ELR PPDU) can determine that the received frame (PPDU) is an ELR PPDU based on the following (1) and (2): (1) The U-SIG field 614 and the UHR-SIG field 615 are subsequent to the U-SIG field 612 and the UHR-SIG field 613; and (2) The modulation methods are the BPSK method and the QBPSK method and are different from each other. As a method for determining that the received PPDU is an ELR PPDU, another method is also considered. For example, this method may include the following (a) and (b): (a) It is determined whether the remainder of dividing the value of a length field included in the RL-SIG field 604 by 3 is a value determined in advance; and (b) (For example, if the remainder is the value determined in advance) the difference between the modulation method for the U-SIG field 612 and the UHR-SIG field 613 and the modulation method for the U-SIG field 614 and the UHR-SIG field 615 is determined. For example, the value determined in advance is 2. The modulation method for the U-SIG field 612 and the UHR-SIG field 613 and the modulation method for the U-SIG field 614 and the UHR-SIG field 615 are differentiated from each other, whereby it is possible to perform long-distance communication without a discrepancy in recognition between communication apparatuses.

In the present embodiment, the modulation method for the U-SIG field 612 and the UHR-SIG field 613 and the modulation method for the U-SIG field 614 and the UHR-SIG field 615 are the BPSK method and the QBPSK method, respectively. The present disclosure, however, is not limited to this. As the modulation method for the U-SIG field 612 and the UHR-SIG field 613 and the modulation method for the U-SIG field 614 and the UHR-SIG field 615, other modulation methods different from each other may be used.

Subsequent to the UHR-SIG field 615, a UHR-SIG field 616 may exist. The modulation method for the UHR-SIG field 616 subsequent to the UHR-SIG field 615 may be the BPSK method, or may be the QBPSK method.

The configuration of a U-SIG field (each of the U-SIG fields 612 and 614) may be similar to the configuration illustrated in table 1. The U-SIG field is composed of a U-SIG 1 field and a U-SIG 2 field.

The U-SIG 2 field includes a UHR-SIG MCS field indicating an MCS used to modulate a subsequent UHR-SIG field.

The UHR-SIG MCS field specifies the MCS of each subsequent UHR-SIG field. The details of the MCS of each UHR-SIG field may be similar to those illustrated in FIG. 7. Alternatively, for example, a form may be employed in which the MCS of each of the UHR-SIG fields 613, 615, and 616 is fixed by BSPK and is not specified in the U-SIG field. In the case of an ELR PPDU, the value of the UHR-SIG MCS field may be a fixed value. That is, a form may be employed in which in the case of an ELR PPDU, the MCS of each of the UHR-SIG fields 613, 615, and 616 is fixed, but the UHR-SIG MCS field indicates the MCS.

The number of UHR-SIG fields can be specified by the number of UHR-SIG repetition field included in each of the U-SIG fields 612 and 614. In the present embodiment, since the UHR-SIG fields 613, 615, and 616 exist, the value of the number of UHR-SIG repetition field is 3.

The value stored in the number of UHR-SIG repetition field may be the number of UHR-SIG fields, or may be a value obtained by subtracting a certain value from the number of UHR-SIG fields. For example, in a form in which an ELR PPDU always includes the UHR-SIG fields 613, 615, and 616, a value obtained by subtracting 2 from the number of UHR-SIG fields can be stored in the number of UHR-SIG repetition field. In the present embodiment, 1 obtained by subtracting 2 from 3 is the value indicated by the number of UHR-SIG repetition field.

The number of UHR-SIG fields can be specified by a U-SIG field in the above description, but may be a fixed number. The number of UHR-SIG fields may be the same as the number of U-SIG fields. In this case, the number of UHR-SIG fields may be variable, and the number of UHR-SIG fields may be indicated by a (e.g., new) field or element in another field preceding the UHR-SIG field.

The UHR-SIG field includes a GI+LTF size field specifying the length of a GI and the number of subsequent UHR-LTF fields.

The ELR PPDU illustrated in FIG. 6B includes an STF for the UHR (a UHR-STF 617) and LTFs for the UHR (a UHR-LTF 618, . . . ). The number of UHR-LTFs is specified by the GI+LTF size field. A form may be employed in which in the case of an ELR PPDU, power is boosted by 3 dB, for example, on the UHR-STF 617 and the UHR-LTF 618 ( . . . ) compared to a PPDU in another format. The amount of the power boosting is not limited to 3 dB. Consequently, the UHR-STF 617 and the UHR-LTF 618 ( . . . ) subsequent to the UHR-SIG fields 613, 615, and 616 have transmission intensities higher than those of other fields. The power boosting improves the SNR of each of these fields, and an improvement in the ELR PPDU transmission possible distance between a transmission terminal and a reception terminal can be expected.

The ELR PPDU includes a data field and a packet extension field (not illustrated) after these fields for control. The fields from the L-STF to the UHR-LTFs included in the ELR PPDU are termed a “PHY preamble”.

The placement of the fields included in the PHY preamble is not limited to the examples illustrated in FIGS. 6A and 6B, and these fields may be placed in another order. The preamble may not include all the fields illustrated in FIGS. 6A and 6B, and may include only some of the fields. To the preamble, another field different from the fields illustrated in FIGS. 6A and 6B may be added. The fields included in the PHY preamble are placed as in the examples illustrated in FIGS. 6A and 6B, whereby communication efficiency can be improved. In the PHY preamble, the fields except for the legacy fields may be collectively referred to as an “ELR preamble”.

FIGS. 5A and 5B in the present embodiment each illustrate as an example a PPDU capable of ensuring backward compatibility. If, however, it is not necessary to ensure backward compatibility, for example, the legacy fields may be omitted. In this case, for example, to establish synchronization, the UHR-STF and the UHR-LTFs are used instead of the L-STF and the L-LTF. In this case, one of the UHR-STF and the plurality of UHR-LTFs after the UHR-SIG can be omitted.

As described above, according to the present embodiment, through the use of the ELR PPDU illustrated in FIG. 6A or 6B, it is possible to appropriately perform communication using an ELR PPDU without a discrepancy in recognition between communication apparatuses. That is, a communication apparatus can perform long-distance communication according to the example of processing illustrated in FIG. 4 using the ELR PPDU illustrated in FIG. 6A or 6B.

A storage medium storing a program code of software for achieving the above functions may be supplied to a system or an apparatus, and a computer (a CPU or an MPU) of the system or the apparatus may read and execute the program code stored in the storage medium. In this case, the program code itself read from the storage medium achieves the functions of the above embodiments, and the storage medium storing the program code constitutes the above apparatus.

As the storage medium for supplying the program code, for example, a flexible disk, a hard disk, an optical disc, a magneto-optical disc, a CD-ROM, a CD-R, a magnetic tape, a non-volatile memory card, a ROM, a DVD, or the like can be used.

Not only may the above functions be achieved by executing the program code read by the computer, but also the above functions may be achieved by an OS, while operating on the computer, performing a part or all of actual processing based on an instruction from the program code.

Further, the program code read from the storage medium may be written to a memory included in a function extension board inserted into the computer or a function extension unit connected to the computer.

Then, a CPU included in the function extension board or the function extension unit may perform a part or all of actual processing based on an instruction from the program code, thereby achieving the above functions.

The present disclosure can also be achieved by the process of supplying a program for achieving one or more functions of the above embodiments to a system or an apparatus via a network or a storage medium, and of causing one or more processors of a computer of the system or the apparatus to read and execute the program. The present disclosure can also be achieved by a circuit (e.g., an ASIC) for achieving the one or more functions.

A part of the processing described with reference to the flowchart in the present disclosure may be achieved by hardware. For example, a dedicated circuit may be automatically generated on an FPGA according to a program for achieving steps, using a predetermined compiler. Alternatively, a gate array circuit may be formed similarly to the FPGA and achieved as hardware.

The names of the functional units, the messages, the parameters, the fields, and the like described in the above embodiments may be changed to other names.

The orders in the processing procedures, the sequences, the flowcharts, and the like in the above embodiments are not limited to the presented particular orders, and may be replaced, or additional steps may be added, unless there is a contradiction.

According to an aspect of the present disclosure, it is possible to appropriately perform communication using a PPDU for long-distance communication.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-210127, filed Dec. 3, 2024, which is hereby incorporated by reference herein in its entirety.

What is claimed is:

1. A communication apparatus compliant with an Institute of Electrical and Electronics Engineers (IEEE) 802.11 standard series, the communication apparatus comprising:
at least one memory storing a program; and
at least one processor that, upon execution of the stored program, is configured to operate as:
a transmission unit configured to transmit a physical layer protocol data unit (PPDU) having a preamble including:
a first universal signal (U-SIG) field, a second U-SIG field including data the same as data in the first U-SIG field, a first ultra high reliability signal (UHR-SIG) field, and a second UHR-SIG field including data the same as data in the first UHR-SIG field, wherein the first U-SIG field and the second U-SIG field are modulated by different modulation methods from each other.

2. The communication apparatus according to claim 1, wherein the first UHR-SIG field and the second UHR-SIG field are modulated by different modulation methods from each other.

3. The communication apparatus according to claim 1, wherein the first U-SIG field and the second U-SIG field include information regarding repetition of predetermined fields subsequent to the second U-SIG field.

4. The communication apparatus according to claim 1, wherein the first UHR-SIG field and the second UHR-SIG field include information regarding repetition of predetermined fields subsequent to the second U-SIG field.

5. The communication apparatus according to claim 1, wherein the first U-SIG field and the second U-SIG field include values indicating modulation methods for the first UHR-SIG field and the second UHR-SIG field.

6. The communication apparatus according to claim 1, wherein all or some fields subsequent to the second UHR-SIG field have transmission intensities higher than transmission intensities of other fields.

7. A communication apparatus compliant with an IEEE 802.11 standard series, the communication apparatus comprising:
at least one memory storing a program; and
at least one processor that, upon execution of the stored program, is configured to operate as:
a reception unit configured to receive a PPDU having a preamble including:
a first U-SIG field, a second U-SIG field including data the same as data in the first U-SIG field, a first UHR-SIG field, and a second UHR-SIG field including data the same as data in the first UHR-SIG field, wherein the first U-SIG field and the second U-SIG field are modulated by different modulation methods from each other.

8. The communication apparatus according to claim 7, wherein the first UHR-SIG field and the second UHR-SIG field are modulated by different modulation methods from each other.

9. The communication apparatus according to claim 7, wherein the first U-SIG field and the second U-SIG field include information regarding repetition of predetermined fields subsequent to the second U-SIG field.

10. The communication apparatus according to claim 7, wherein the first UHR-SIG field and the second UHR-SIG field include information regarding repetition of predetermined fields subsequent to the second U-SIG field.

11. The communication apparatus according to claim 7, wherein the first U-SIG field and the second U-SIG field include values indicating modulation methods for the first UHR-SIG field and the second UHR-SIG field.

12. A control method for controlling a communication apparatus compliant with an IEEE 802.11 standard series, the control method comprising:
transmitting a PPDU having a preamble including:
a first U-SIG field, a second U-SIG field including data the same as data in the first U-SIG field, a first UHR-SIG field, and a second UHR-SIG field including data the same as data in the first UHR-SIG field, wherein the first U-SIG field and the second U-SIG field are modulated by different modulation methods from each other.

13. A control method for controlling a communication apparatus compliant with an IEEE 802.11 standard series, the control method comprising:
receiving a PPDU having a preamble including:
a first U-SIG field, a second U-SIG field including data the same as data in the first U-SIG field, a first UHR-SIG field, and a second UHR-SIG field including data the same as data in the first UHR-SIG field, wherein the first U-SIG field and the second U-SIG field are modulated by different modulation methods from each other.

14. A non-transitory computer-readable storage medium storing instructions that, when executed by a computer, cause the computer to perform a control method for controlling a communication apparatus compliant with an IEEE 802.11 standard series, the control method comprising:
transmitting a PPDU having a preamble including:
a first U-SIG field, a second U-SIG field including data the same as data in the first U-SIG field, a first UHR-SIG field, and a second UHR-SIG field including data the same as data in the first UHR-SIG field, wherein the first U-SIG field and the second U-SIG field are modulated by different modulation methods from each other.

15. A non-transitory computer-readable storage medium storing instructions that, when executed by a computer, cause the computer to perform a control method for controlling a communication apparatus compliant with an IEEE 802.11 standard series, the control method comprising:
receiving a PPDU having a preamble including:
a first U-SIG field, a second U-SIG field including data the same as data in the first U-SIG field, a first UHR-SIG field, and a second UHR-SIG field including data the same as data in the first UHR-SIG field, wherein the first U-SIG field and the second U-SIG field are modulated by different modulation methods from each other.
